(19) United States
(12) Patent Application Publication
(10) Pub. No.: US 2006/0099079 A1
(43) Pub. Date: May 11, 2006

(54) Iron-based sintered alloy, iron base sintered alloy member, method for production thereof, and oil pump rotor

(76) Inventors: Kinya Kawase, Niigata-shi (JP); Yoshinari Ishii, Niigata-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/541,308

(22) PCT Filed: Oct. 20, 2003
(86) PCT No.: PCT/JP03/13379

§ 371 Date: Jul. 5, 2005

(30) Foreign Application Priority Data
Jan. 8, 2003 (JP) 2003-1662

(51) Int. Cl. F03B 3/12; B63H 1/26

(52) U.S. Cl. 416/241 R

(57) ABSTRACT

An iron-based sintered alloy member having a composition consisting of 0.5 to 7% by mass of Cu, 0.1 to 0.98% by mass of C, 0.02 to 0.3% by mass of oxygen and, optionally, 0.0025 to 1.05% by mass of Mn and/or 0.001 to 0.7% by mass of Zn, and the balance of Fe and inevitable impurities is manufactured by formulating an Fe powder, a graphite powder and a Cu alloy powder, as raw powders, mixing the powders to form a powder mixture, forming the powder mixture into a green compact and sintering the green compact. The Cu alloy powder has a composition consisting of 1 to 10% by mass of Fe, 0.2 to 1% by mass of oxygen and, optionally, 0.2 to 10% by mass of Zn and/or 0.5 to 15% by mass of Mn, and the balance of Cu and inevitable impurities.

### TECHNICAL FIELD

The present invention relates to an iron-based sintered alloy and to an iron-based sintered alloy member, which are superior in dimensional accuracy, strength and slidability, to a method of manufacturing the same, and to an oil pump rotor made of the iron-based sintered alloy.

### BACKGROUND ART

With recent progress in methods of manufacturing iron-based sintered alloy members, it has become possible to mass-produce various machine parts such as oil pump rotors with high accuracy using an iron-based sintered alloy member which is superior in dimensional accuracy, strength, and slidability.

As an example of a method of manufacturing this kind of iron-based sintered alloy member, there is provided a method of manufacturing an iron-based sintered alloy member which is superior in dimensional accuracy, strength and slidability, the method comprising press-forming a powder mixture, which is obtained by adding 0.01 to 0.20% of an oxide powder such as aluminum oxide powder, titanium oxide powder, silicon oxide powder, vanadium oxide powder or chromium oxide powder to a powder mixture of an Fe powder, a Cu powder and a graphite powder, into a green compact and sintering the green compact (see Japanese Patent Application, First Publication No. Hei 6-41609).

Such an iron-based sintered alloy member has a texture composed of an aggregate of base material cells made of an Fe-based alloy containing Cu and C, which are partitioned with an old Fe powder boundary formed by sintering an Fe powder, and metal oxide grains are dispersed inside pores scattered in the texture, or dispersed along the old Fe powder boundary.

However, the iron-based sintered alloy member manufactured by the above conventional method is insufficient in dimensional accuracy and strength, although the dimensional accuracy is improved to some degree, and therefore it has been required to develop a method of manufacturing an iron-based sintered alloy member which is markedly superior in dimensional accuracy, strength and slidability. The resulting iron-based sintered alloy member is not suited for use as a material of sliding machine parts such as in an oil pump rotor.

### DISCLOSURE OF THE INVENTION

A first aspect of the present invention is directed to a method of manufacturing an iron-based sintered alloy member having a composition consisting of, by mass (hereinafter percentages are by mass), 0.5 to 7% of Cu, 0.1 to 0.98% of C, 0.02 to 0.3% of oxygen, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder has a composition consisting of 1 to 10% of Fe, 0.2 to 1% of oxygen, and the balance of Cu and inevitable impurities.

Further example of the first aspect of the present invention is directed to a method of manufacturing an iron-based sintered alloy member having a composition consisting of 0.5 to 7% of Cu, 0.1 to 0.98% of C, 0.02 to 0.3% of oxygen, 0.0025 to 1.05% of Mn, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder has a composition consisting of at least one selected from the group consisting of 1 to 10% of Fe, 0.2 to 1% of oxygen and 0.5 to 15% of Mn, and the balance of Cu and inevitable impurities.

Yet another example of the first aspect of the present invention is directed to a method of manufacturing an iron-based sintered alloy member having a composition consisting of 0.5 to 7% of Cu, 0.1 to 0.98% of C, 0.02 to 0.3% of oxygen, 0.001 to 0.7% of Zn, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder has a composition consisting of 1 to 10% of Fe, 0.2 to 1% of oxygen, 0.2 to 10% of Zn, and the balance of Cu and inevitable impurities.

Other examples of the first aspect of the present invention are directed to a method of manufacturing an iron-based sintered alloy member having a composition consisting of 0.5 to 7% of Cu, 0.1 to 0.98% of C, 0.02 to 0.3% of oxygen, 0.0025 to 1.05% of Mn, 0.001 to 0.7% of Zn, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder has a composition consisting of 1 to 10% of Fe, 0.2 to 1% of oxygen, 0.2 to 10% of Zn, 0.5 to 15% of Mn, and the balance of Cu and inevitable impurities.

Other examples of the first aspect of the present invention are directed to a method of manufacturing an iron-based sintered alloy member having a composition consisting of 0.5 to 7% of Cu, 0.1 to 0.98% of C, 0.02 to 0.3% of oxygen, 0.001 to 0.14% in total of at least one selected from the group consisting of Al and Si, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder has a composition consisting of 1 to 10% of Fe, 0.2 to 1% of oxygen, 0.01 to 2% in total of at least one selected from the group consisting of Al and Si, and the balance of Cu and inevitable impurities.

Other examples of the first aspect of the present invention are directed to a method of manufacturing an iron-based sintered alloy member having a composition consisting of 0.5 to 7% of Cu, 0.1 to 0.98% of C, 0.02 to 0.3% of oxygen, 0.0025 to 1.05% of Mn, 0.001 to 0.14% in total of at least one selected from the group consisting of Al and Si, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder has a composition consisting of at least one selected from the group consisting of 1 to 10% of Fe, 0.2 to 1% of oxygen, 0.5 to 15% of Mn, 0.01 to 2% in total of at least one selected from the group consisting of Al and Si, and the balance of Cu and inevitable impurities.

Other examples of the first aspect of the present invention are directed to a method of manufacturing an iron-based sintered alloy member having a composition consisting of 0.5 to 7% of Cu, 0.1 to 0.98% of C, 0.02 to 0.3% of oxygen, 0.001 to 0.7% of Zn, 0.001 to 0.14% in total of at least one selected from the group consisting of Al and Si, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder has a composition consisting of 1 to 10% of Fe, 0.2 to 1% of oxygen, 0.2 to 10% of Zn, 0.01 to 2% in total of at least one selected from the group consisting of Al and Si, and the balance of Cu and inevitable impurities.

Other examples of the first aspect of the present invention are directed to a method of manufacturing an iron-based sintered alloy member having a composition consisting of 0.5 to 7% of Cu, 0.1 to 0.98% of C, 0.02 to 0.3% of oxygen, 0.0025 to 1.05% of Mn, 0.001 to 0.7% of Zn, 0.001 to 0.14% in total of at least one selected from the group consisting of Al and Si, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder has a composition consisting of 1 to 10% of Fe, 0.2 to 1% of oxygen, 0.2 to 10% of Zn, 0.5 to 15% of Mn, 0.01 to 2% in total of at least one selected from the group consisting of Al and Si, and the balance of Cu and inevitable impurities.

A second aspect of the present invention is directed to an oil pump rotor made of an iron-based sintered alloy, comprising an iron-based sintered alloy having a composition consisting of, by mass (hereinafter percentages are by mass), 0.5 to 7% of Cu, 0.1 to 0.98% of C, 0.02 to 0.3% of oxygen, and the balance of Fe and inevitable impurities.

Further examples of the second aspect of the present invention are directed to an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.0025 to 1.05% of Mn, and the balance of Fe and inevitable impurities.

Yet further examples of the second aspect of the present invention are directed to an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.001 to 0.7% of Zn, and the balance of Fe and inevitable impurities.

Other examples of the second aspect of the present invention are directed to an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.0025 to 1.05% of Mn, 0.001 to 0.7% of Zn, and the balance of Fe and inevitable impurities.

Other examples of the second aspect of the present invention are directed to an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.001 to 0.14% in total of at least one selected from the group consisting of Al and Si, and the balance of Fe and inevitable impurities.

Other examples of the second aspect of the present invention are directed to an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.0025 to 1.05% of Mn, 0.001 to 0.14% in total of at least one selected from the group consisting of Al and Si, and the balance of Fe and inevitable impurities.

Other examples of the second aspect of the present invention are directed to an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.001 to 0.7% of Zn, 0.001 to 0.14% in total of at least one selected from the group consisting of Al and Si, and the balance of Fe and inevitable impurities.

Other examples of the second aspect of the present invention are directed to an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.0025 to 1.05% of Mn, 0.001 to 0.7% of Zn, 0.001 to 0.14% in total of at least one selected from the group consisting of Al and Si, and the balance of Fe and inevitable impurities.

A third aspect of the present invention is directed to an iron-based sintered alloy which has a composition consisting of, by mass, 0.5 to 10% of Cu, 0.1 to 0.98% of C, 0.02 to 0.3% of oxygen, and the balance of Fe and inevitable impurities, and also has a texture composed of an aggregate of base material cells made of an Fe-based alloy containing C, Cu and O, which are partitioned with an old Fe powder boundary formed by sintering an Fe powder, as raw powders, wherein the base material cells made of the Fe-based alloy containing C, Cu and O, which are partitioned with the old Fe powder boundary, have such a gradient concentration that the concentration of Cu and O in the vicinity of the old Fe powder boundary is higher than the concentration of Cu and O of the center portion of the base material cell.

### BRIEF DESCRIPTION OF THE DRAWING

FIG. 1 is a schematic view showing concentration distribution of Cu and O of base material cells in the texture of an iron-based sintered alloy according to the present invention observed by EPMA.

### BEST MODE FOR CARRYING OUT THE INVENTION

### First Aspect

The present inventors have intensively researched the manufacture of an iron-based sintered alloy member which is superior in dimensional accuracy, strength and slidability, and thus the following findings were obtained.

(a) According to a conventional method of manufacturing an iron-based sintered alloy member by formulating an Fe powder, a graphite powder and a Cu alloy powder, mixing the powders to form a powder mixture, forming the powder mixture into a green compact and sintering the green compact, when the powder mixture of the Fe powder, the graphite powder and the Cu powder is sintered, the Cu powder is first melted during sintering to form a Cu liquid phase. Because of good wetting properties with Fe, the Cu liquid phase penetrates into an Fe powder boundary, thereby causing breakage of bonds between Fe powders. Therefore, the strength of the resulting sintered body decreases and the sintered body expands, resulting in poor dimensional accuracy.

(b) To improve the dimensional accuracy without decreasing the strength of the sintered body, a Cu alloy powder containing 1 to 10% of Fe and 0.2 to 1% of oxygen is used, as raw powders, in place of a Cu powder, and an Fe powder, graphite powder and the Cu alloy powder are mixed and formed into a green compact, which is then sintered. Consequently, wetting properties between the Cu liquid phase and the Fe powder deteriorate and penetration of Cu into the Fe powder boundary is suppressed. Therefore, expansion of the sintered body is suppressed and the dimensional accuracy is improved and, furthermore, bonding strength between Fe powders does not decrease. When oxygen is not added in the form of a metal oxide, but in the form of a solid solution with a Cu alloy powder, oxygen is concentrated in the portion having high Cu concentration in the texture of the iron-based sintered alloy member, thereby improving the slidability. Therefore, an iron-based sintered alloy member having a composition consisting of 0.5 to 7% of Cu, 0.1 to 0.98% of C, 0.02 to 0.3% of oxygen, and the balance of Fe and inevitable impurities obtained by this method is superior in dimensional accuracy, strength and slidability.

(c) When the Cu alloy powder used as raw powders is a Cu alloy powder containing 1 to 10% of Fe, 0.2 to 1% of oxygen and 0.5 to 15% of Mn, Mn can maintain the concentration of oxygen contained in the Cu alloy powder at a higher level and also increases the oxygen concentration of a Cu liquid phase produced during sintering, thereby further suppressing penetration of the Cu liquid phase into spaces between Fe grains. Consequently, expansion of the sintered body due to the Cu liquid phase is suppressed, thereby further improving dimensional accuracy of the sintered body. Furthermore, the oxygen concentration of the portion having high Cu concentration in the texture of the iron-based sintered alloy member increases, thereby improving slidability.

(d) When the Cu alloy powder used as raw powders is a Cu alloy powder containing 1 to 10% of Fe, 0.2 to 1% of oxygen and 0.2 to 10% of Zn, Zn can maintain the concentration of oxygen contained in the Cu alloy powder at higher level and also diffuses into Fe at a temperature lower than that of the Cu liquid phase, while Zn in Fe deteriorates wetting properties between the Cu liquid phase and Fe grains. Therefore, expansion of the sintered body due to the Cu liquid phase is suppressed, thereby further improving dimensional accuracy of the sintered body. Thus, decrease in strength caused by breakage of Fe powders of the Cu liquid phase is prevented and slidability is improved, thereby to improving anti-seizing properties.

The method of manufacturing an iron-based sintered alloy member according to a first aspect of the present invention has the following constitutions:

(A1) a method of manufacturing an iron-based sintered alloy member having a composition consisting of 0.5 to 7% of Cu, 0.1 to 0.98% of C, 0.02 to 0.3% of oxygen, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein a powder having a composition consisting of 1 to 10% of Fe, 0.2 to 1% of oxygen, and the balance of Cu and inevitable impurities is used as the Cu alloy powder;

(A2) a method of manufacturing an iron-based sintered alloy member having a composition consisting of 0.5 to 7% of Cu, 0.1 to 0.98% of C, 0.02 to 0.3% of oxygen, 0.0025 to 1.05% of Mn, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein a powder having a composition consisting of at least one selected from the group consisting of 1 to 10% of Fe, 0.2 to 1% of oxygen and 0.5 to 15% of Mn, and the balance of Cu and inevitable impurities is used as the Cu alloy powder;

(A3) a method of manufacturing an iron-based sintered alloy member having a composition consisting of 0.5 to 7% of Cu, 0.1 to 0.98% of C, 0.02 to 0.3% of oxygen, 0.001 to 0.7% of Zn, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein a powder having a composition consisting of 1 to 10% of Fe, 0.2 to 1% of oxygen, 0.2 to 10% of Zn, and the balance of Cu and inevitable impurities is used as the Cu alloy powder; and

(A4) a method of manufacturing an iron-based sintered alloy member having a composition consisting of 0.5 to 7% of Cu, 0.1 to 0.98% of C, 0.02 to 0.3% of oxygen, 0.0025 to 1.05% of Mn, 0.001 to 0.7% of Zn, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein a power having a composition consisting of 1 to 10% of Fe, 0.2 to 1% of oxygen, 0.2 to 10% of Zn, 0.5 to 15% of Mn, and the balance of Cu and inevitable impurities is used as the Cu alloy powder.

Since Al and Si components exert the effect of increasing the oxygen concentration of the Cu alloy powder, a Cu alloy powder containing 0.01 to 2% in total of at least one selected from the group consisting of Al and Si is used as raw powders and the Cu alloy powder is formulated, together with an Fe powder and a graphite powder, mixed and formed into a green compact, which is then sintered. In this case, there can be obtained any one of the following four kinds of iron-based sintered alloy members:

an iron-based sintered alloy member having a composition consisting of 0.5 to 7% of Cu, 0.1 to 0.98% of C, 0.02 to 0.3% of oxygen, 0.001 to 0.14% in total of at least one selected from the group consisting of Al and Si, and the balance of Fe and inevitable impurities;

an iron-based sintered alloy member having a composition consisting of 0.5 to 7% of Cu, 0.1 to 0.98% of C, 0.02 to 0.3% of oxygen, 0.0025 to 1.05% of Mn, 0.001 to 0.14% in total of at least one selected from the group consisting of Al and Si, and the balance of Fe and inevitable impurities;

an iron-based sintered alloy member having a composition consisting of 0.5 to 7% of Cu, 0.1 to 0.98% of C, 0.02 to 0.3% of oxygen, 0.001 to 0.7% of Zn, 0.001 to 0.14% in total of at least one selected from the group consisting of Al and Si, and the balance of Fe and inevitable impurities; and

an iron-based sintered alloy member having a composition consisting of 0.5 to 7% of Cu, 0.1 to 0.98% of C, 0.02 to 0.3% of oxygen, 0.0025 to 1.05% of Mn, 0.001 to 0.7% of Zn, 0.001 to 0.14% in total of at least one selected from the group consisting of Al and Si, and the balance of Fe and inevitable impurities.

Therefore, the first aspect also includes the following methods:

(A5) a method of manufacturing an iron-based sintered alloy member having a composition consisting of 0.5 to 7% of Cu, 0.1 to 0.98% of C, 0.02 to 0.3% of oxygen, 0.001 to 0.14% in total of at least one selected from the group consisting of Al and Si, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder is a Cu alloy powder having a composition consisting of 1 to 10% of Fe, 0.2 to 1% of oxygen, 0.01 to 2% in total of at least one selected from the group consisting of Al and Si, and the balance of Cu and inevitable impurities;

(A6) a method of manufacturing an iron-based sintered alloy member having a composition consisting of 0.5 to 7% of Cu, 0.1 to 0.98% of C, 0.02 to 0.3% of oxygen, 0.0025 to 1.05% of Mn, 0.001 to 0.14% in total of at least one selected from the group consisting of Al and Si, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder is a Cu alloy powder having a composition consisting of at least one selected from the group consisting of 1 to 10% of Fe, 0.2 to 1% of oxygen and 0.5 to 15% of Mn, 0.01 to 2% in total of at least one selected from the group consisting of Al and Si, and the balance of Cu and inevitable impurities;

(A7) a method of manufacturing an iron-based sintered alloy member having a composition consisting of 0.5 to 7% of Cu, 0.1 to 0.98% of C, 0.02 to 0.3% of oxygen, 0.001 to 0.7% of Zn, 0.001 to 0.14% in total of at least one selected from the group consisting of Al and Si, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder is a Cu alloy powder having a composition consisting of 1 to 10% of Fe, 0.2 to 1% of oxygen, 0.2 to 10% of Zn, 0.01 to 2% in total of at least one selected from the group consisting of Al and Si, and the balance of Cu and inevitable impurities; and

(A8) a method of manufacturing an iron-based sintered alloy member having a composition consisting of 0.5 to 7% of Cu, 0.1 to 0.98% of C, 0.02 to 0.3% of oxygen, 0.0025 to 1.05% of Mn, 0.001 to 0.7% of Zn, 0.001 to 0.14% in total of at least one selected from the group consisting of Al and Si, and the balance of Fe and inevitable impurities, which comprises formulating an Fe powder, a graphite powder and a Cu alloy powder, as raw powders, mixing the powders to form a powder mixture, forming the powder mixture into a green compact and sintering the green compact, wherein the Cu alloy powder is a Cu alloy powder having a composition consisting of 1 to 10% of Fe, 0.2 to 1% of oxygen, 0.2 to 10% of Zn, 0.5 to 15% of Mn, 0.01 to 2% in total of at least one selected from the group consisting of Al and Si, and the balance of Cu and inevitable impurities.

The reasons for the compositions of the Cu alloy powder, as raw powders used in the method of manufacturing the iron-based sintered alloy member according to the first aspect, will now be described.

Fe contained in Cu alloy powder:

Fe is a component which deteriorates wetting properties with the Fe powder rather than the Cu powder and also suppresses expansion of the sintered body due to the Cu liquid phase by using it, as raw powders, in the form of a Cu alloy powder containing 1 to 10% of Fe, and thus dimensional accuracy of the sintered body is further improved. When the content is less than 1%, desired effects cannot be obtained. On the other hand, when the content exceeds 10%, compressibility upon powder molding deteriorates, and it is not preferable. Therefore, the amount of Fe contained in the Cu alloy powder was defined within a range from 1 to 10%.

Oxygen contained in Cu alloy powder:

Oxygen contained in the Cu alloy powder concentrates oxygen in the portion having high Cu concentration and also improves dimensional accuracy, strength and slidability. When the content is less than 0.2%, it is made impossible to sufficiently concentrate oxygen in the portion having high Cu concentration. On the other hand, when the content exceeds 1%, the strength of the iron-based sintered alloy member obtained by sintering decreases, and it is not preferable. Therefore, the amount of oxygen contained in the Cu alloy powder was defined within a range from 0.2 to 1%.

Mn contained in Cu alloy powder:

Mn exerts the following effects. That is, Mn can maintain the concentration of oxygen contained in the Cu alloy powder at a higher level and also increases the oxygen concentration in the Cu liquid phase produced during sintering, thereby suppressing penetration of the Cu liquid phase into spaces between Fe grains, and thus expansion of the sintered body due to the Cu liquid phase is suppressed and dimensional accuracy of the sintered body is further improved. Also Mn increases oxygen concentration of the portion having high Cu concentration in the texture of the iron-based sintered alloy member, thereby improving slidability. When the content is less than 0.5%, desired effects cannot be obtained. On the other hand, when the content exceeds 15%, the amount of Mn contained in the iron-based sintered alloy member exceeds 1.05%, thereby deteriorating the toughness, and this is not preferable. Therefore, the amount of Mn contained in the Cu alloy powder was defined within a range from 0.5 to 15%.

Zn contained in Cu alloy powder:

Zn exerts the following effects. That is, Zn can maintain the concentration of oxygen contained in the Cu alloy powder at a higher level and also diffuses into Fe at a temperature lower than that of the Cu liquid phase. Zn in Fe deteriorates wetting properties between the Cu liquid phase and Fe grains, and thus expansion of the sintered body due to the Cu liquid phase is suppressed and dimensional accuracy of the sintered body is further improved. Also Zn prevents decrease in strength due to breakage of Fe powders of the Cu liquid phase and improves the slidability, thereby improving anti-seizing properties. When the content is less than 0.2%, the amount of Zn contained in the iron-based sintered alloy member becomes too small, such as 0.001 or less, and a desired effect cannot be obtained. On the other hand, when the content exceeds 10%, the amount of Zn contained in the iron-based sintered alloy member exceeds 0.7% and the toughness deteriorates, and it is not preferable. Therefore, the amount of Zn contained in the Cu alloy powder was defined within a range from 0.2 to 10%.

Al and Si contained in Cu alloy powder:

Al and Si are optionally added because they exert the effect of increasing the oxygen concentration of the Cu alloy powder. Even when the total amount of at least one selected from the group consisting of Al and Si is less than 0.01%, the amount of Al and Si contained in the iron-based sintered alloy member is less than 0.001% and a desired effect cannot be obtained. On the other hand, when the total amount of at least one selected from the group consisting of Al and Si exceeds 2%, the amount of Al and Si contained in the iron-based sintered alloy member exceeds 0.14% and the strength rather decreases, and it is not preferable. Therefore, the amount of Al and Si contained in the iron-based sintered alloy member was defined within a range from 0.01 to 2%.

Specifically, the method of manufacturing the iron-based sintered alloy member according to the first aspect may be a method comprising preparing a Cu alloy powder having a composition described in any of (A1) to (A8), as raw powders, preparing an Fe powder and a graphite powder, formulating these raw powders in a predetermined amount, mixing them with a zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C. The sintering temperature is more preferably from 1100 to 1260° C.

### Second Aspect

The oil pump rotor according to the second aspect of the present invention employs the above iron-based sintered alloy member and has the following constituents:

(B1) an oil pump rotor made of an iron-based sintered alloy, comprising an iron-based sintered alloy having a composition consisting of 0.5 to 7% of Cu, 0.1 to 0.98% of C, 0.02 to 0.3% of oxygen, and the balance of Fe and inevitable impurities;

(B2) an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.0025 to 1.05% of Mn, and the balance of Fe and inevitable impurities;

(B3) an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.001 to 0.7% of Zn, and the balance of Fe and inevitable impurities; and

(B4) an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.0025 to 1.05% of Mn, 0.001 to 0.7% of Zn, and the balance of Fe and inevitable impurities.

The oil pump rotor (B1) can be manufactured by formulating a predetermined amount of an Fe powder, a graphite powder and a Cu alloy powder having a composition consisting of 1 to 10% of Fe, 0.2 to 1% of oxygen, and balance of Cu and inevitable impurities, as raw powders, mixing them with zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

The oil pump rotor (B2) can be manufactured by formulating a predetermined amount of an Fe powder, a graphite powder and a Cu alloy powder having a composition consisting of 1 to 10% of Fe, 0.2 to 1% of oxygen, 0.5 to 15% of Mn, and balance of Cu and inevitable impurities, as raw powders, mixing them with zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

The oil pump rotor (B3) can be manufactured by formulating a predetermined amount of an Fe powder, a graphite powder and a Cu alloy powder having a composition consisting of 1 to 10% of Fe, 0.2 to 1% of oxygen, 0.2 to 10% of Zn, and balance of Cu and inevitable impurities, as raw powders, mixing them with zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

The oil pump rotor (B4) can be manufactured by formulating a predetermined amount of an Fe powder, a graphite powder and a Cu alloy powder having a composition consisting of 1 to 10% of Fe, 0.2 to 1% of oxygen, 0.2 to 10% of Zn, 0.5 to 15% of Mn, and balance of Cu and inevitable impurities, as raw powders, mixing them with zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

Since the Al and Si components exert the effect of increasing the oxygen concentration of the Cu alloy powder, an oil pump rotor made of an iron-based sintered alloy may be manufactured by using a Cu alloy powder containing 0.01 to 2% in total of at least one selected from the group consisting of Al and Si, as raw powders, formulating the Cu alloy powder, together with an Fe powder and a graphite powder, mixing them, forming the powder mixture, forming the powder mixture into a green compact, and sintering the green compact.

In this case, there can be obtained the following oil pump rotors:

(B5) an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.001 to 0.14% in total of at least one selected from the group consisting of Al and Si, and the balance of Fe and inevitable impurities;

(B6) an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.0025 to 1.05% of Mn, 0.001 to 0.14% in total of at least one selected from the group consisting of Al and Si, and the balance of Fe and inevitable impurities;

(B7) an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.001 to 0.7% of Zn, 0.001 to 0.14% in total of at least one selected from the group consisting of Al and Si, and the balance of Fe and inevitable impurities; and

(B8) an oil pump rotor made of an iron-based sintered alloy, comprising an iron-based sintered alloy having a composition consisting of 0.5 to 7% of Cu, 0.1 to 0.98% of C, 0.02 to 0.3% of oxygen, 0.0025 to 1.05% of Mn, 0.001 to 0.7% of Zn, 0.001 to 0.14% in total of at least one selected from the group consisting of Al and Si, and the balance of Fe and inevitable impurities.

The oil pump rotor (B5) can be manufactured by formulating a predetermined amount of an Fe powder, a graphite powder and a Cu alloy powder having a composition consisting of 1 to 10% of Fe, 0.2 to 1% of oxygen, 0.01 to 2% in total of at least one selected from the group consisting of Al and Si, and the balance of Cu and inevitable impurities, as raw powders, mixing them with zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

The oil pump rotor (B6) can be manufactured by formulating a predetermined amount of an Fe powder, a graphite powder and a Cu alloy powder having a composition consisting of 1 to 10% of Fe, 0.2 to 1% of oxygen, 0.5 to 15% of Mn, 0.01 to 2% in total of at least one selected from the group consisting of Al and Si, and the balance of Cu and inevitable impurities, as raw powders, mixing them with zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

The oil pump rotor (B7) can be manufactured by formulating a predetermined amount of an Fe powder, a graphite powder and a Cu alloy powder having a composition consisting of 1 to 10% of Fe, 0.2 to 1% of oxygen, 0.2 to 10% of Zn, 0.01 to 2% in total of at least one selected from the group consisting of Al and Si, and the balance of Cu and inevitable impurities, as raw powders, mixing them with zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

The oil pump rotor (B8) can be manufactured by formulating a predetermined amount of an Fe powder, a graphite powder and a Cu alloy powder having a composition consisting of 1 to 10% of Fe, 0.2 to 1% of oxygen, 0.2 to 10% of Zn, 0.5 to 15% of Mn, 0.01 to 2% in total of at least one selected from the group consisting of Al and Si, and the balance of Cu and inevitable impurities, as raw powders, mixing them with zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

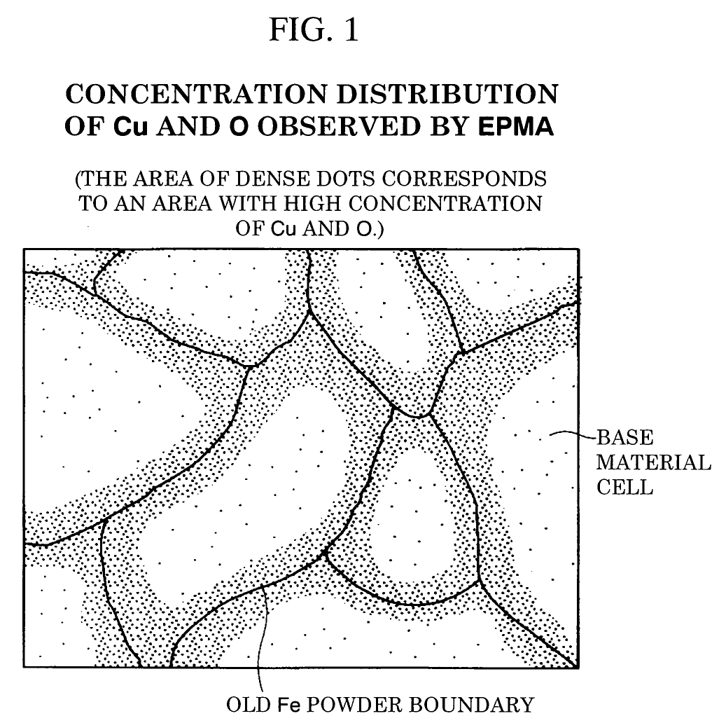

It was confirmed by EPMA (electron probe X-ray microanalysis) that the iron-based sintered alloy, which constitutes the oil pump rotor made of the iron-based sintered alloy having the composition of any one of (B1) to (B8) has such a texture that base material cells containing Fe, as a main component, Cu and O, which are partitioned with an old Fe powder boundary formed by sintering the Fe powder, as raw powders, are aggregated to form a basis material and the base material cells partitioned with the old Fe powder boundary have such a gradient concentration that the concentration of Cu and O in the vicinity of the old Fe powder boundary is higher than the concentration of Cu and O of the center portion of the base material cell. FIG. 1 is a schematic view showing concentration distribution of Cu and O in a base material cell of the oil pump rotor made of the iron-based sintered alloy of the present invention observed by EPMA. The area of dense dots corresponds to an area with high concentration of Cu and O. As shown in FIG. 1, base material cells containing Fe, as a main component, Cu and O, which are partitioned with an old Fe powder boundary formed by sintering the Fe powder, as raw powders, are aggregated to form a basis material and the base material cells have such a concentration that the concentration of Cu and O in the vicinity of the old Fe powder boundary is higher than the concentration of Cu and O of the center portion of the base material cell. Therefore, the texture of the oil pump rotor made of the iron-based sintered alloy having the composition of any of (B1) to (B8) is different from a conventional texture wherein metal oxide grains are dispersed along the old Fe powder boundary.

The reason for the composition of the iron-based sintered alloy constituting the oil pump rotor made of the iron-based sintered alloy according to the present invention will now be described.

Cu:

Cu is a component which improves sintering properties of the Fe powder, thereby improving dimensional accuracy of the resulting sintered body. When the amount of Cu contained in the iron-based sintered alloy is less than 0.5%, a desired effect cannot be obtained. On the other hand, when the amount exceeds 7%, the strength decreases, and it is not preferable. Therefore, the Cu content was defined within a range from 0.5 to 7%.

C:

C is a component which improves the strength and slidability of the iron-based sintered alloy. When the content is less than 0.1%, a desired effect cannot be obtained. On the other hand, when the content exceeds 0.98%, the slidability and toughness of the iron-based sintered alloy obtained by sintering deteriorate, and it is not preferable. Therefore, the C content was defined within a range from 0.1 to 0.98%.

Oxygen:

In the iron-based sintered alloy wherein oxygen in the portion having high Cu concentration in a basis material and in the vicinity of the basis material is concentrated, the dimensional accuracy, strength and slidability are further improved. When the content is less than 0.02%, it is made impossible to sufficiently concentrate oxygen in the portion having high Cu concentration. On the other hand, when the content exceeds 0.3%, the strength of the iron-based sintered alloy obtained by sintering decreases, and it is not preferable. Therefore, the amount of oxygen contained in the iron-based sintered alloy was defined within a range from 0.02 to 0.3%. In this case, when oxygen is dispersed in the form of metal oxide grains, mating attackability increases, and thus it is necessary to incorporate oxygen in the form of a solid solution in the portion having high Cu concentration.

Mn:

Mn exerts the following effects. That is, Mn can maintain the concentration of oxygen contained in the Cu alloy powder at a higher level and also increases the oxygen concentration in the Cu liquid phase produced during sintering, thereby suppressing penetration of the Cu liquid phase into spaces between Fe grains, and thus expansion of the sintered body due to the Cu liquid phase is suppressed and dimensional accuracy of the sintered body is further improved. Also Mn increases oxygen concentration of the portion having high Cu concentration in the texture of the iron-based sintered alloy member, thereby improving slidability. When the content is less than 0.0025%, desired effects cannot be obtained. On the other hand, when the content exceeds 1.05%, the toughness of the iron-based sintered alloy deteriorates, and it is not preferable. Therefore, the amount of Mn contained in the iron-based sintered alloy was defined within a range from 0.0025 to 1.05%.

Zn:

Zn exerts the following effects. That is, Zn can maintain the concentration of oxygen contained in the Cu alloy powder at a higher level and also diffuses into Fe at a temperature lower than that of the Cu liquid phase. Zn in Fe deteriorates wetting properties between the Cu liquid phase and Fe grains, and thus expansion of the sintered body due to the Cu liquid phase is suppressed and dimensional accuracy of the sintered body is further improved. Also Zn prevents decrease in strength due to breakage of Fe powders of the Cu liquid phase and improves the slidability, thereby to improve anti-seizing properties. When the content is less than 0.001%, a desired effect cannot be obtained. On the other hand, when the amount contained in the iron-based sintered alloy exceeds 0.7%, the toughness deteriorates, and it is not preferable. Therefore, the amount of Zn contained in the iron-based sintered alloy was defined within a range from 0.001 to 0.7%.

Al and Si:

Al and Si are optionally added because they exert an effect of increasing the oxygen concentration of the Cu alloy powder. Even when the total amount of at least one selected from the group consisting of Al and Si is less than 0.001%, a desired effect cannot be obtained. On the other hand, when the total amount of at least one selected from the group consisting of Al and Si exceeds 0.14%, the strength rather decreases, and it is not preferable. Therefore, the amount of Al and Si contained in the iron-based sintered alloy was defined within a range from 0.001 to 0.14%.

### Third Aspect

The present inventors have intensively researched, and thus the following findings were obtained.

(a) In a conventional iron-based sintered alloy obtained by formulating an Fe powder, a graphite powder, a Cu alloy powder and a metal oxide powder, mixing the powders to form a powder mixture, forming the powder mixture into a green compact and sintering the green compact, since the powder mixture of the Fe powder, the graphite powder, the Cu alloy powder and the metal oxide powder is sintered, the Cu powder is first melted during sintering to form a Cu liquid phase. Because of good wetting properties with Fe, the Cu liquid phase penetrates into an Fe powder boundary, thereby causing breakage of a bond between Fe powders. Therefore, the strength of the resulting sintered body decreases and the sintered body expands, resulting in poor dimensional accuracy. Also the metal oxide powder added is aggregated inside pores, or dispersed along the old Fe powder boundary, and thus a friction coefficient increases, thereby deteriorating sliding properties.

(b) To solve problems in conventional iron-based sintered alloys, a Cu alloy powder containing 1 to 10% of Fe and 0.2 to 1% of oxygen is used, as raw powders, in place of a Cu powder, and an Fe powder, graphite powder and the Cu alloy powder containing 1 to 10% of Fe and 0.2 to 1% of oxygen are mixed, and the resulting powder mixture is formed into a green compact, which is then sintered. Consequently, penetration of Cu alloy liquid phase into the Fe powder boundary is suppressed because of poor wetting properties between the Cu liquid phase produced during sintering and the Fe powder. Therefore, expansion of the sintered body is suppressed and the dimensional accuracy is improved and, furthermore, bonding strength between Fe powders does not decrease. Since oxygen is added in the form of a solid solution with a Cu alloy powder, oxygen is concentrated in the portion having high Cu concentration in the texture of the iron-based sintered alloy member. Such a texture noticeably decreases a friction coefficient as compared with a conventional texture wherein metal oxide grains are dispersed, thereby to improve sliding properties. Therefore, an iron-based sintered alloy having a composition consisting of 0.5 to 10% of Cu, 0.1 to 0.98% of C, 0.02 to 0.3% of oxygen, and the balance of Fe and inevitable impurities obtained by this method is superior in dimensional accuracy, strength and sliding properties.

(c) An iron-based sintered alloy manufactured by using a Cu alloy powder containing 1 to 10% of Fe and 0.2 to 1% of oxygen, as raw powders, has a texture composed of an aggregate of base material cells made of an Fe-based alloy containing C, Cu and O, which are partitioned with an old Fe powder boundary formed by sintering an Fe powder, as raw powders. The base material cells partitioned with the old Fe powder boundary have such a gradient concentration that the concentration of Cu and O is large in the vicinity of the old Fe powder boundary and decreases toward the center portion of the base material cell, though C is uniformly incorporated into the base material cells in the form of a solid solution.

The third aspect of the present invention has been made based on the research results described above and has the following constitution:

(C1) an iron-based sintered alloy which has a composition consisting of 0.5 to 10% of Cu, 0.1 to 0.98% of C, 0.02 to 0.3% of oxygen, and the balance of Fe and inevitable impurities, and also has a texture composed of an aggregate of base material cells made of an Fe-based alloy containing C, Cu and O, which are partitioned with an old Fe powder boundary formed by sintering an Fe powder, as raw powders, wherein the base material cells made of the Fe-based alloy containing C, Cu and O, which are partitioned with the old Fe powder boundary, have such a gradient concentration that the concentration of Cu and O in the vicinity of the old Fe powder boundary is higher than the concentration of Cu and O of the center portion of the base material cell.

The iron-based sintered alloy according to the third aspect of the present invention may contain at least one selected from the group consisting of N, Mo, Mn, Cr, Zn, Sn, P and Si for the purpose of improving the strength.

In the iron-based sintered alloy according to the third aspect of the present invention, the base material cells made of the Fe-based alloy containing C, Cu and O, which are partitioned with the old Fe powder boundary, often have such a gradient concentration that the concentration of Cu and O is maximum in the vicinity of the old Fe powder boundary, while the concentration of Cu and O decreases toward the center portion of the base material cell and reached a minimum value at the center of the base material cell, as a result of control of a sintering time, and it is more preferable that the iron-based sintered alloy have such a texture.

The iron-based sintered alloy according to the third aspect of the present invention further includes the following constitution:

(C2) an iron-based sintered alloy which has a composition consisting of, by mass, 0.5 to 10% of Cu, 0.1 to 0.98% of C, 0.02 to 0.3% of oxygen, and the balance of Fe and inevitable impurities, and also has a texture composed of an aggregate of base material cells made of an Fe-based alloy containing C, Cu and O, which are partitioned with an old Fe powder boundary formed by sintering an Fe powder, as raw powders, wherein the base material cells made of the Fe-based alloy containing C, Cu and O, which are partitioned with the old Fe powder boundary, have such a gradient concentration that the concentration of Cu and O is maximum in the vicinity of the old Fe powder boundary, while the concentration of Cu and O decreases toward the center portion of the base material cell and reached a minimum value at the center of the base material cell.

The iron-based sintered alloys having a composition consisting of 0.5 to 10% of Cu, 0.1 to 0.98% of C, 0.02 to 0.3% of oxygen, and the balance of Fe and inevitable impurities described in (C1) and (C2) can be manufactured by formulating a predetermined amount of an Fe powder, a graphite powder and a Cu alloy powder having a composition consisting of 1 to 10% of Fe, 0.2 to 1% of oxygen, and the balance of Cu and inevitable impurities, as raw powders, mixing them with a zinc stearate powder or ethylenebisamide, as a lubricant, in a double corn mixer, press-forming the powder mixture into a green compact, and sintering the green compact in a hydrogen atmosphere containing nitrogen at a temperature of 1090 to 1300° C.

The iron-based sintered alloy according to the third aspect of the present invention has a texture composed of an aggregate of base material cells made of an Fe-based alloy containing C, Cu and O, which are partitioned with an old Fe powder boundary formed by sintering an Fe powder, as raw powders. The base material cells have such a gradient concentration that the concentration of Cu and O in the vicinity of the old Fe powder boundary is higher than the concentration of Cu and O of the center portion of the base material cell. This was confirmed by EPMA (electron probe X-ray microanalysis).

FIG. 1 is a schematic view showing concentration distribution of Cu and O in base material cells, which are partitioned with an old Fe powder boundary of the texture of the iron-based sintered alloy of the present invention, observed by EPMA. The area of dense dots corresponds to an area with high concentration of Cu and O. As shown in FIG. 1, base material cells containing Fe, as a main component, Cu and O, which are partitioned with an old Fe powder boundary formed by sintering the Fe powder, as raw powders, are aggregated to form a basis material and the base material cells partitioned with the old Fe powder boundary have such a concentration that the concentration of Cu and O in the vicinity of the old Fe powder boundary is higher than the concentration of Cu and O of the center portion of the base material cell. Therefore, the texture of the iron-based sintered alloy having the composition of any of (C1) to (C2) according to the third aspect of the present invention is different from a conventional texture wherein metal oxide grains are dispersed along the old Fe powder boundary.

The reason for the composition of the iron-based sintered alloy according to the third aspect of the present invention will now be described.

Cu:

Cu is a component which improves sintering properties of the Fe powder, thereby improving dimensional accuracy of the resulting sintered body. When the amount of Cu contained in the iron-based sintered alloy is less than 0.5%, a desired effect cannot be obtained. On the other hand, when the amount exceeds 10%, the strength decreases, and it is not preferable. Therefore, the Cu content was defined within a range from 0.5 to 10%.

C:

C is a component which improves the strength and sliding properties of the iron-based sintered alloy. When the content is less than 0.1%, a desired effect cannot be obtained. On the other hand, when the content exceeds 0.98%, sliding properties and toughness of the iron-based sintered alloy obtained by sintering deteriorate, and it is not preferable. Therefore, the C content was defined within a range from 0.1 to 0.98%.

Oxygen:

In the iron-based sintered alloy wherein oxygen in the portion having high Cu concentration in a basis material and in the vicinity of the basis material is concentrated, the dimensional accuracy, strength and slidability are further improved. When the content is less than 0.02%, it is made impossible to sufficiently concentrate oxygen in the portion having high Cu concentration. On the other hand, when the content exceeds 0.3%, the strength of the iron-based sintered alloy obtained by sintering decreases, and it is not preferable. Therefore, the amount of oxygen contained in the iron-based sintered alloy was defined within a range from 0.02 to 0.3%.

By using a Cu alloy powder containing 1 to 10% of Fe and 0.2 to 1% of oxygen in place of the Cu powder, as raw powders, the resulting base material cells have such a gradient concentration that the concentration of Cu and O in the vicinity of the old Fe powder boundary is higher than the concentration of Cu and O of the center portion of the base material cell. The Cu alloy powder having a composition of 1 to 10% of Fe was used as raw powders for the following reason. That is, when the content of Fe is less than 1%, less effects of improving the dimensional accuracy of the sintered body is exerted, and it is not preferable. On the other hand, when the content of Fe exceeds 10%, the compressibility upon formation into a green compact deteriorates, and it is not preferable. The content of oxygen was controlled within a range from 0.2 to 1% for the following reason. When the content of oxygen is less than 0.2%, less effect of improving the dimensional accuracy of the sintered body is exerted, and it is not preferable. On the other hand, when the content of oxygen exceeds 1%, the toughness deteriorates, and it is not preferable.

### Example of First Aspect

As raw powders, an atomized Fe powder having an average grain size of 80 μm, a graphite powder having an average grain size of 15 μm, Cu alloy powders A to U each having the average grain size and composition shown in Table 1, a pure Cu powder and a MnO powder were prepared.

TABLE 1

| | | Composition (% by mass) | | | | | | |
|---|---|---|---|---|---|---|---|---|
| | | | | | | | | Cu and |
| | | | | | | | | inevitable |
| Classification | | Fe | O | Mn | Zn | Al | Si | impurities |
| Cu alloy | A | 1.2 | 0.25 | — | — | — | — | balance |
| powders | B | 4.1 | 0.36 | — | — | — | — | balance |
| | C | 9.5 | 0.52 | — | — | — | — | balance |
| | D | 5.2 | 0.35 | 0.8 | — | — | — | balance |
| | E | 3.8 | 0.68 | 6.5 | — | — | — | balance |
| | F | 4.5 | 0.94 | 14.3 | — | — | — | balance |
| | G | 2.9 | 0.31 | — | 9.3 | — | — | balance |
| | H | 4.1 | 0.58 | — | 5.2 | — | — | balance |
| | I | 3.7 | 0.67 | — | 0.25 | — | — | balance |
| | J | 3.3 | 0.42 | 1.8 | 1.5 | — | — | balance |
| | K | 3.8 | 0.81 | 1.8 | 7.4 | — | — | balance |
| | L | 5.2 | 0.88 | 0.58 | 0.84 | — | — | balance |
| | M | 4.4 | 0.45 | — | — | — | 0.03 | balance |
| | N | 4.7 | 0.42 | — | — | 0.03 | — | balance |
| | 0 | 4.1 | 0.77 | — | — | 0.93 | 0.94 | balance |
| | P | 4.2 | 0.49 | 1.1 | 3.6 | 0.06 | 0.07 | balance |
| | Q | 3.7 | 0.50 | 7.6 | 2.2 | 0.04 | 0.06 | balance |
| | R | 0.5* | 0.21 | — | — | — | — | balance |
| | S | 11* | 0.45 | — | — | — | — | balance |
| | T | 3.8 | 0.1* | — | — | — | — | balance |
| | U | 6.7 | 1.2* | — | — | — | — | balance |

Note:
symbol * denotes a value that is not within the scope of the first aspect

These raw powders were formulated according to the compositions shown in Table 2 to Table 3 and mixed with zinc stearate powder, as a lubricant used upon metallic molding, in an amount of 0.8% in terms of an outer percentage, and then the powder mixture was press-formed into a bar-shaped green compact measuring 10 mm×10 mm×50 mm under a compacting pressure of 600 MPa. The resulting bar-shaped green compact was sintered in an endothermic gas atmosphere under the conditions of a temperature of 1140° C. for 20 minutes to obtain a bar-shaped test piece, and Examples A1 to A17, Comparative Examples A1 to A4 and Conventional Example A1 were carried out.

The size of the bar-shaped test pieces made in Examples A1 to A17, Comparative Examples A1 to A4 and Conventional Example A1 was measured and a dimensional change ratio of a standard size of the green compact was determined. The dimensional accuracy was evaluated by the results shown in Table 2 to Table 3. A Charpy impact value was determined by a Charpy impact test. The results are shown in Table 2 to Table 3. Furthermore, the bar-shaped test pieces were machined to obtain tensile test pieces. Using these tensile test pieces, tensile strength was measured. The results are shown in Table 2 to Table 3.

Furthermore, wear test pieces each measuring 5 mm×3 mm×40 mm and a SS330 (rolled steel for general structure) ring having an outer diameter of 45 mm and an inner diameter of 27 mm were prepared by machining the bar-shaped test piece. Each wear test piece was pressed against the ring rotating at a rotation number of 1500 rpm and a rotational speed of 3.5 m/second while increasing a pressing load, and then a load at which seizing occurred was measured. The results are shown in Table 2 to Table 3.

TABLE 2

| | | Composition of raw powder (% by mass) | | | | | | | | | | |
|---|---|---|---|---|---|---|---|---|---|---|---|---|
| | | Cu alloy | | | | | | | | | | |
| | | powder in | Graphite | Fe | Composition of iron-based sintered alloy member (% by mass) | | | | | | | |
| Classification | | Table 1 | powder | powder | Cu | C | O | Mn | Zn | Al | Si | Fe |
| Examples | A1 | A: 6.7 | 1.15 | balance | 6.61 | 0.97 | 0.07 | — | — | — | — | balance |
| | A2 | B: 3 | 0.8 | balance | 2.86 | 0.93 | 0.05 | — | — | — | — | balance |
| | A3 | C: 5 | 1.1 | balance | 4.50 | 0.92 | 0.11 | — | — | — | — | balance |
| | A4 | D: 5 | 1.1 | balance | 4.67 | 0.94 | 0.07 | 0.037 | — | — | — | balance |
| | A5 | E: 4 | 1.0 | balance | 3.54 | 0.89 | 0.13 | 0.26 | — | — | — | balance |
| | A6 | F: 7 | 1.0 | balance | 5.61 | 0.87 | 0.28 | 1.00 | — | — | — | balance |
| | A7 | G: 6 | 1.0 | balance | 5.23 | 0.85 | 0.06 | — | 0.551 | — | — | balance |
| | A8 | H: 2.5 | 0.8 | balance | 2.24 | 0.72 | 0.04 | — | 0.130 | — | — | balance |
| | A9 | I: 1.5 | 0.7 | balance | 1.41 | 0.60 | 0.02 | — | 0.004 | — | — | balance |
| | A10 | J: 2 | 0.7 | balance | 1.83 | 0.61 | 0.03 | 0.036 | 0.028 | — | — | balance |
| | A11 | K: 3 | 0.9 | balance | 2.56 | 0.78 | 0.09 | 0.051 | 0.220 | — | — | balance |
| | A12 | L: 1 | 0.2 | balance | 0.93 | 0.18 | 0.03 | 0.006 | 0.006 | — | — | balance |

| | | | | |
|---|---|---|---|---|
| | Dimensional | Charpy impact | Tensile | Load upon |
| Classification | change ratio (%) | value (J/cm²) | strength (MPa) | seizing (N) |

| | | | | | |
|---|---|---|---|---|---|
| Examples | A1 | 0.15 | 25 | 596 | 686 |
| | A2 | 0.05 | 18 | 620 | 588 |
| | A3 | 0.14 | 22 | 567 | 686 |
| | A4 | 0.13 | 24 | 537 | 686 |
| | A5 | 0.12 | 20 | 603 | 686 |
| | A6 | 0.15 | 25 | 575 | 980 |
| | A7 | 0.13 | 21 | 623 | 784 |
| | A8 | 0.04 | 17 | 642 | 588 |
| | A9 | 0.03 | 19 | 562 | 490 |
| | A10 | 0.05 | 22 | 580 | 588 |
| | A11 | 0.04 | 21 | 655 | 686 |
| | A12 | 0.13 | 17 | 573 | 490 |

TABLE 3

| | | Composition of raw powder (% by mass) | | | | | | | | | | |
|---|---|---|---|---|---|---|---|---|---|---|---|---|
| | | Cu alloy | | | | | | | | | | |
| | | powder in | Graphite | Fe | Composition of iron-based sintered alloy member (% by mass) | | | | | | | |
| Classification | | Table 1 | powder | powder | Cu | C | O | Mn | Zn | Al | Si | Fe |
| Examples | A13 | M: 3.5 | 0.9 | balance | 2.83 | 0.79 | 0.07 | — | — | — | 0.0011 | balance |
| | A14 | N: 3.5 | 0.8 | balance | 2.84 | 0.70 | 0.05 | — | — | 0.0012 | — | balance |
| | A15 | O: 6.5 | 1.1 | balance | 6.03 | 0.9 | 0.21 | — | — | 0.060 | 0.060 | balance |
| | A16 | P: 3 | 0.8 | balance | 2.68 | 0.71 | 0.05 | 0.632 | 0.103 | 0.0015 | 0.0021 | balance |
| | A17 | Q: 3 | 0.9 | balance | 2.58 | 0.78 | 0.06 | 0.227 | 0.050 | 0.0011 | 0.0015 | balance |
| Comparative | A1 | R: 3 | 0.9 | balance | 2.94 | 0.77 | 0.02 | — | — | — | — | balance |
| Examples | A2 | S: 3 | 0.9 | balance | 2.98 | 0.80 | 0.05 | — | — | — | — | balance |
| | A3 | T: 3 | 0.9 | balance | 2.65 | 0.78 | 0.01 | — | — | — | — | balance |
| | A4 | U: 3 | 0.9 | balance | 2.83 | 0.77 | 0.13 | — | — | — | — | balance |

| | | | | | | | | | | | |
|---|---|---|---|---|---|---|---|---|---|---|---|
| Conventional | Pure Cu: 3 | 0.9 | balance | 2.98 | 0.80 | 0.03 | — | — | — | — | balance |
| Example A1 | MnO: 0.1 | | | | | | | | | | |

| | | | | |
|---|---|---|---|---|
| | Dimensional | Charpy impact | Tensile | Load upon |
| Classification | change ratio (%) | value (J/cm²) | strength (MPa) | seizing (N) |

| | | | | | |
|---|---|---|---|---|---|
| Examples | A13 | 0.06 | 18 | 623 | 588 |
| | A14 | 0.07 | 18 | 610 | 588 |
| | A15 | 0.14 | 25 | 629 | 980 |
| | A16 | 0.06 | 21 | 628 | 784 |
| | A17 | 0.02 | 19 | 644 | 882 |
| Comparative | A1 | 0.23 | 12 | 394 | 196 |
| Examples | A2 | 0.15 | 9 | 421 | 294 |
| | A3 | 0.28 | 13 | 410 | 196 |
| | A4 | 0.13 | 8 | 346 | 686 |

| | | | | |
|---|---|---|---|---|
| Conventional | 0.36 | 7 | 375 | 196 |
| Example A1 | | | | |

As is apparent from the results shown in Table 2 and Table 3, comparing Examples A1 to A17 with Conventional Example Al, test pieces made in Examples A1 to A17 are superior in dimensional accuracy because a dimensional change ratio is smaller than that of the test piece made in Conventional Example A1, and exhibits high Charpy impact value and high tensile strength, and is also superior in slidability because of less wear amount of the ring. However, test pieces of Comparative Examples A1 to A4, which use a Cu powder having a composition that is not within the scope of the first aspect, are inferior in at least one of dimensional accuracy, Charpy impact value, tensile strength and wear amount.

### Example of Second Aspect

As raw powders, an atomized Fe powder having an average grain size of 80 μm, a graphite powder having an average grain size of 15 μm, Cu alloy powders A to R each having the average grain size and composition shown in Table 4, a pure Cu powder, and a MnO powder were prepared.

TABLE 4

| | | Composition (% by mass) | | | | | | |
|---|---|---|---|---|---|---|---|---|
| | | | | | | | | Cu and |
| | | | | | | | | inevitable |
| Classification | | Fe | O | Mn | Zn | Al | Si | impurities |
| Cu alloy | A | 1.2 | 0.25 | — | — | — | — | balance |
| powders | B | 4.1 | 0.36 | — | — | — | — | balance |
| | C | 9.5 | 0.52 | — | — | — | — | balance |
| | D | 5.2 | 0.35 | 0.8 | — | — | — | balance |
| | E | 3.8 | 0.68 | 6.5 | — | — | — | balance |
| | F | 4.5 | 0.94 | 14.3 | — | — | — | balance |
| | G | 2.9 | 0.31 | — | 9.3 | — | — | balance |
| | H | 4.1 | 0.58 | — | 5.2 | — | — | balance |
| | I | 3.7 | 0.67 | — | 0.25 | — | — | balance |
| | J | 3.3 | 0.42 | 1.8 | 1.5 | — | — | balance |
| | K | 3.8 | 0.81 | 1.8 | 7.4 | — | — | balance |
| | L | 5.2 | 0.88 | 0.58 | 0.84 | — | — | balance |
| | M | 4.4 | 0.45 | — | — | — | 0.03 | balance |
| | N | 4.7 | 0.42 | — | — | 0.03 | — | balance |
| | O | 4.1 | 0.77 | — | — | 0.93 | 0.94 | balance |
| | P | 4.2 | 0.49 | 1.1 | 3.6 | 0.06 | 0.07 | balance |
| | Q | 3.8 | 0.98 | — | — | — | — | balance |
| | R | 4.2 | 0.13 | — | — | — | — | balance |

These raw powders were formulated according to the compositions shown in Table 5 to Table 6 and mixed with zinc stearate powder, as a lubricant used upon metallic molding, in an amount of 0.8% in terms of an outer percentage, and then the powder mixture was press-formed into a bar-shaped green compact measuring 10 mm×10 mm×50 mm under a compacting pressure of 600 MPa. The resulting bar-shaped green compact was sintered in an endothermic gas atmosphere under the conditions of a temperature of 1140° C. for 20 minutes to obtain bar-shaped test pieces (hereinafter referred to as Examples) B1 to B16 made of iron-based sintered alloys, which constitute the oil pump rotor of the present invention, each having the composition shown in Table 5 to Table 6, bar-shaped test pieces (hereinafter referred to as Comparative Examples) B1 to B6 made of iron-based sintered alloys which constitute the comparative oil pump rotor, and a bar-shaped test piece (hereinafter referred to as Conventional Example) B1 made of an iron-based sintered alloy which constitutes the conventional oil pump rotor.

With regard to Examples B1 to B16, Comparative Examples B1 to B6 and Conventional Example B1, concentration distribution of Cu and O in the basis material was observed by EPMA. The results are shown in Table 5 and Table 6.

The sizes of Examples B1 to B16, Comparative Examples B1 to B6 and Conventional Example B1 were measured and a dimensional change ratio of a standard size of the green compact was determined. The dimensional accuracy was evaluated by the results shown in Table 7.

A Charpy impact value was determined by a Charpy impact test. The results are shown in Table 7. Furthermore, Examples B1 to B16, Comparative Examples B1 to B6 and Conventional Example B1 were machined to obtain tensile test pieces. Using these tensile test pieces, a tensile strength was measured. The results are shown in Table 7.

Furthermore, wear test pieces each measuring 5 mm×3 mm×40 mm obtained by machining Examples B1 to B16, Comparative Examples B1 to B6 and Conventional Example B1 and a SS330 (rolled steel for general structure) ring having an outer diameter of 45 mm and an inner diameter of 27 mm were prepared by machining the bar-shaped test piece. Each wear test piece was pressed against the ring rotating at a rotation number of 1500 rpm and a rotational speed of 3.5 m/second while increasing a pressing load, and then a load at which seizing occurred was measured. The results are shown in Table 7.

TABLE 5

| | | Composition of raw powder (% by mass) | | | | | | | | | | | |
|---|---|---|---|---|---|---|---|---|---|---|---|---|---|
| | | Cu alloy | | | | | | | | | | | |
| | | powder in | Graphite | Fe | Composition (% by mass) | | | | | | | | |
| Test pieces | | Table 4 | powder | powder | Cu | C | O | Mn | Zn | Al | Si | Fe | Texture |
| Examples | B1 | A: 6.7 | 1.15 | balance | 6.61 | 0.97 | 0.07 | — | — | — | — | Fe | The concentration of |
| | B2 | B: 3 | 0.8 | balance | 2.86 | 0.93 | 0.05 | — | — | — | — | balance | Cu and O in the vicinity |
| | B3 | C: 5 | 1.1 | balance | 4.50 | 0.92 | 0.11 | — | — | — | — | balance | of an old Fe powder |
| | B4 | D: 5 | 1.1 | balance | 4.67 | 0.94 | 0.07 | 0.037 | — | — | — | balance | boundary is higher than |
| | B5 | E: 4 | 1.0 | balance | 3.54 | 0.89 | 0.13 | 0.26 | — | — | — | balance | the concentration of Cu |
| | B6 | F: 7 | 1.0 | balance | 5.61 | 0.87 | 0.28 | 1.00 | — | — | — | balance | and O of the center portion. |
| | B7 | G: 6 | 1.0 | balance | 5.23 | 0.85 | 0.06 | — | 0.551 | — | — | balance | |
| | B8 | H: 2.5 | 0.8 | balance | 2.24 | 0.72 | 0.04 | — | 0.130 | — | — | balance | |
| | B9 | I: 1.5 | 0.7 | balance | 1.41 | 0.60 | 0.02 | — | 0.004 | — | — | balance | |
| | B10 | J: 2 | 0.7 | balance | 1.83 | 0.61 | 0.03 | 0.036 | 0.028 | — | — | balance | |
| | B11 | K: 3 | 0.9 | balance | 2.56 | 0.78 | 0.09 | 0.051 | 0.220 | — | — | balance | |
| | B12 | L: 1 | 0.2 | balance | 0.93 | 0.18 | 0.03 | 0.006 | 0.006 | — | — | balance | |

TABLE 6

| | | Composition of raw powder | | | | | | | | | | | |
|---|---|---|---|---|---|---|---|---|---|---|---|---|---|
| | | (% by mass) | | | | | | | | | | | |
| | | Cu alloy | | | | | | | | | | | |
| | | powder in | Graphite | Fe | Composition (% by mass) | | | | | | | | |
| Test pieces | | Table 4 | powder | powder | Cu | C | O | Mn | Zn | Al | Si | Fe | Texture |
| Examples | B13 | M: 3.5 | 0.9 | balance | 2.83 | 0.79 | 0.07 | — | — | — | 0.0011 | balance | The concentra- |
| | B14 | N: 3.5 | 0.8 | balance | 2.84 | 0.70 | 0.05 | — | — | 0.0012 | — | balance | tion of Cu and |
| | B15 | O: 6.5 | 1.1 | balance | 6.03 | 0.90 | 0.21 | — | — | 0.060 | 0.060 | balance | O in the vicinity |
| | B16 | P: 3 | 0.8 | balance | 2.68 | 0.71 | 0.05 | 0.632 | 0.103 | 0.0015 | 0.0021 | balance | of an old Fe |
| Compar- | B1 | B: 7.5 | 0.9 | balance | 7.25* | 0.77 | 0.02 | — | — | — | — | balance | powder boundary |
| ative | B2 | B: 0.4 | 0.9 | balance | 0.33* | 0.80 | 0.05 | — | — | — | — | balance | is higher than |
| Examples | B3 | B: 3 | 1.2 | balance | 2.65 | 1.01* | 0.02 | — | — | — | — | balance | the concentra- |
| | B4 | B: 3 | 0.1 | balance | 2.83 | 0.06* | 0.13 | — | — | — | — | balance | tion of Cu and |
| | B5 | Q: 3 | 0.9 | balance | 2.85 | 0.82 | 0.4* | — | — | — | — | balance | O of the center |
| | B6 | R: 3 | 0.9 | balance | 2.85 | 0.81 | 0.01* | — | — | — | — | balance | portion. |
| Conven- | B1 | Pure Cu: 3 | 0.9 | balance | 2.98 | 0.03 | 0.03 | 0.027 | — | — | — | balance | MnO grains are |
| tional | | MnO: 0.1 | | | | | | | | | | | dispersed in a |
| Example | | | | | | | | | | | | | basis material. |

Note:
symbol * denotes a value that is not within the second aspect of the present invention

TABLE 7

| | | Dimensional | Charpy | | Load |
|---|---|---|---|---|---|
| | | change | impact | Tensile | upon |
| | | ratio | value | strength | seizing |
| Test pieces | | (%) | (J/cm²) | (MPa) | (N) |
| Examples | B1 | 0.15 | 25 | 596 | 686 |
| | B2 | 0.05 | 18 | 620 | 588 |
| | B3 | 0.14 | 22 | 567 | 686 |
| | B4 | 0.13 | 24 | 537 | 686 |
| | B5 | 0.12 | 20 | 603 | 686 |
| | B6 | 0.15 | 25 | 575 | 980 |
| | B7 | 0.13 | 21 | 623 | 784 |
| | B8 | 0.04 | 17 | 642 | 588 |
| | B9 | 0.03 | 19 | 562 | 490 |
| | B10 | 0.05 | 22 | 580 | 588 |
| | B11 | 0.04 | 21 | 655 | 686 |
| | B12 | 0.13 | 17 | 573 | 490 |
| | B13 | 0.06 | 18 | 623 | 588 |
| | B14 | 0.07 | 18 | 610 | 588 |
| | B15 | 0.14 | 25 | 629 | 980 |
| | B16 | 0.06 | 21 | 628 | 784 |
| Comparative | B1 | 0.42 | 10 | 431 | 294 |
| Examples | B2 | 0.10 | 7 | 238 | 196 |
| | B3 | 0.28 | 5 | 351 | 294 |
| | B4 | 0.38 | 10 | 225 | 196 |
| | B5 | 0.19* | 8 | 251 | 294 |
| | B6 | 0.22 | 12 | 450 | 196 |

| | | | | |
|---|---|---|---|---|
| Conventional | 0.36 | 7 | 375 | 196 |
| Example B1 | | | | |

As is apparent from the results shown in Table 5 to Table 7, comparing Examples B1 to B16 with Conventional Example B1, Examples B1 to B16 are superior in dimensional accuracy because a dimensional change ratio is smaller than that of Conventional Example B1, and exhibit high Charpy impact value and high tensile strength, and also superior in slidability because of less wear amount of the ring.

However, Comparative Examples B1 to B6 having the composition that is not within the scope of the second aspect are inferior in at least one of dimensional accuracy, Charpy impact value, tensile strength and wear amount. Therefore, oil pump rotors made of an iron-based sintered alloy having the same composition as that of Examples B1 to B16 are superior in dimensional accuracy, strength and slidability to an oil pump rotor made of a conventional iron-based sintered alloy.

### Example of Third Aspect

As raw powders, an atomized Fe powder having an average grain size of 80 μm, a graphite powder having an average grain size of 15 μm, Cu alloy powders A to L each having the average grain size and composition shown in Table 8, a pure Cu powder and a MnO powder were prepared.

TABLE 8

| | | Composition (% by mass) | | |
|---|---|---|---|---|
| Classification | | Fe | O | Cu and inevitable impurities |
| Cu alloy powders | A | 1.2 | 0.25 | balance |
| | B | 4.1 | 0.36 | balance |
| | C | 9.5 | 0.52 | balance |
| | D | 5.2 | 0.35 | balance |
| | E | 3.8 | 0.68 | balance |
| | F | 8.5 | 0.94 | balance |
| | G | 2.9 | 0.31 | balance |
| | H | 4.6 | 0.58 | balance |
| | I | 7.7 | 0.67 | balance |
| | J | 6.3 | 0.42 | balance |
| | K | 3.8 | 0.98 | balance |
| | L | 4.2 | 0.13 | balance |

These raw powders were formulated according to the compositions shown in Table 9 and mixed with zinc stearate powder, as a lubricant used upon metallic molding, in an amount of 0.8% in terms of an outer percentage, and then the powder mixture was press-formed into a bar-shaped green compact measuring 10 mm×10 mm×50 mm under a compacting pressure of 600 MPa. The resulting bar-shaped green compact was sintered in an endothermic gas atmosphere under the conditions of a temperature of 1140° C. for 20 minutes to obtain bar-shaped test pieces of Examples C1 to C10 each having the composition shown in Table 9 to Table 11, bar-shaped test pieces of Comparative Examples C1 to C6 and a bar-shaped test piece (Conventional Example C1) made of a conventional iron-based sintered alloy.

With regard to Examples C1 to C10, Comparative Examples C1 to C6 and Conventional Example C1, concentration distribution of Cu and O in the basis material texture was observed by EPMA. The results are shown in Table 9 to Table 11. The size of these bar-shaped test pieces was measured and a dimensional change ratio of a standard size of the green compact was determined. The dimensional accuracy was evaluated by the results shown in Table 11. A Charpy impact value was determined by a Charpy impact test. The results are shown in Table 11. Furthermore, Examples C1 to C10, Comparative Examples C1 to C6 and Conventional Example C1 were machined to obtain tensile test pieces. Using these tensile test pieces, tensile strength was measured. The results are shown in Table 11.

Furthermore, Examples C1 to C10, Comparative Examples C1 to C6 and Conventional Example C1 were machined to obtain wear test pieces each measuring 5 mm×10 mm×45 mm and a SCM420 ring having an outer diameter of 40 mm and an inner diameter of 27 mm. Using the wear test pieces and ring, the following wear test was conducted and sliding properties were evaluated by the results shown in Table 11.

Wear Test 1

Each wear test piece was pressed against the ring rotating at a rotational speed of 3 m/second while increasing a pressing load, and then a load at which seizing occurred (load upon seizing) was measured. Sliding properties were evaluated by the results shown in Table 11.

Wear Test 2

Each wear test piece was pressed against the ring rotating at a rotational speed of 3 m/second under a load of 20 kgf. After mounting a strain gage in a direction horizontal to a pressing direction, the load calculated from the value of the strain gage was divided by the above pressing load (20 kgf), thereby to obtain a friction coefficient. Sliding properties were evaluated by the results shown in Table 11.

TABLE 9

| | | Composition of raw powder (% by mass) | | | | | | | |
|---|---|---|---|---|---|---|---|---|---|
| | | Cu alloy | | | | | | | |
| Iron-based | | powder in | Graphite | Fe | Composition (% by mass) | | | | |
| sintered alloys | | Table 8 | powder | powder | Cu | C | O | Fe | Texture |
| Examples | C1 | A: 0.6 | 0.8 | balance | 0.6 | 0.71 | 0.02 | balance | Aggregate of base |
| | C2 | B: 2 | 0.8 | balance | 1.8 | 0.72 | 0.04 | balance | material cells |
| | C3 | C: 3 | 0.8 | balance | 2.8 | 0.71 | 0.06 | balance | wherein the |
| | C4 | D: 5 | 0.8 | balance | 4.7 | 0.73 | 0.08 | balance | concentration of |
| | C5 | E: 7 | 0.8 | balance | 6.6 | 0.73 | 0.13 | balance | Cu and O in the |
| | C6 | F: 11 | 0.8 | balance | 9.8 | 0.72 | 0.28 | balance | vicinity of an old |
| | C7 | G: 3 | 0.15 | balance | 2.9 | 0.12 | 0.04 | balance | Fe powder boundary |
| | C8 | H: 3 | 0.3 | balance | 3.0 | 0.28 | 0.07 | balance | is higher than the |
| | C9 | I: 3 | 0.6 | balance | 3.0 | 0.54 | 0.09 | balance | concentration of Cu |
| | C10 | J: 3 | 0.11 | balance | 2.6 | 0.97 | 0.05 | balance | and O of the center |
| | | | | | | | | | portion |

TABLE 10

| | | Composition of raw powder (% by mass) | | | | | | | | |
|---|---|---|---|---|---|---|---|---|---|---|
| | | Cu alloy | | | | | | | | |
| Iron-based | | powder in | graphite | Fe | Composition (% by mass) | | | | | |
| sintered alloys | | Table 8 | powder | powder | Cu | C | O | Mn | Fe | Texture |
| Comparative | C1 | K: 11 | 0.8 | balance | 9.8 | 0.71 | 0.31* | — | balance | Aggregate of base material cells |
| Examples | C2 | L: 0.6 | 0.8 | balance | 0.6 | 0.72 | 0.01* | — | balance | wherein the concentration of Cu and O |
| | C3 | B: 3 | 0.1 | balance | 2.9 | 0.06* | 0.05 | — | balance | in the vicinity of an old Fe powder |
| | C4 | B: 3 | 1.2 | balance | 2.8 | 1.10* | 0.05 | — | balance | boundary is higher than the concentration |
| | C5 | B: 12 | 0.8 | balance | 11.5* | 0.70 | 0.12 | — | balance | of Cu and O of the center portion |
| | C6 | B: 0.4 | 0.8 | balance | 0.4* | 0.71 | 0.03 | — | balance | |

| | | | | | | | | | |
|---|---|---|---|---|---|---|---|---|---|
| Conventional | Pure Cu: 3 | 0.8 | balance | 2.9 | 0.72 | 0.03 | 0.027 | balance | MnO grains are dispersed in a basis material. |
| Example C1 | MnO: 0.1 | | | | | | | | |

Note:
symbol * denotes a value that is not within the scope of the present invention

TABLE 11

| | | Dimensional | Charpy | | Load | |
|---|---|---|---|---|---|---|
| | | change | impact | Tensile | upon | Friction |
| Iron-based | | ratio | value | strength | seizing | coef- |
| sintered alloys | | (%) | (J/cm²) | (MPa) | (N) | ficient |
| Examples | C1 | 0.01 | 25 | 596 | 686 | 0.17 |
| | C2 | 0.01 | 18 | 620 | 588 | 0.15 |
| | C3 | 0.05 | 22 | 567 | 686 | 0.12 |
| | C4 | 0.10 | 20 | 663 | 725 | 0.11 |
| | C5 | 0.14 | 19 | 642 | 993 | 0.08 |
| | C6 | 0.16 | 17 | 695 | 594 | 0.04 |
| | C7 | 0.12 | 24 | 563 | 630 | 0.15 |
| | C8 | 0.08 | 26 | 572 | 705 | 0.12 |
| | C9 | 0.07 | 24 | 645 | 685 | 0.11 |
| | C10 | 0.03 | 23 | 623 | 673 | 0.13 |
| Comparative | C1 | 0.42 | 4 | 431 | 553 | 0.29 |
| Examples | C2 | 0.10 | 10 | 238 | 200 | 0.32 |
| | C3 | 0.18 | 9 | 351 | 215 | 0.24 |
| | C4 | 0.13 | 8 | 225 | 235 | 0.26 |
| | C5 | 0.55 | 5 | 405 | 264 | 0.21 |
| | C6 | 0.12 | 10 | 380 | 245 | 0.31 |

| | | | | | |
|---|---|---|---|---|---|
| Conventional | 0.36 | 7 | 375 | 180 | 0.33 |
| Example C1 | | | | | |

As is apparent from the results shown in Table 9 to Table 11, comparing bar-shaped test pieces of Examples C1 to C10 with the bar-shaped test piece of Conventional Example C1, the bar-shaped test pieces of Examples C1 to C10 are superior in dimensional accuracy because a dimensional change ratio is smaller than that of the test piece made of Conventional Example C1, and exhibit high Charpy impact value and high tensile strength. Also the bar-shaped test pieces of Examples C1 to C10 are made of alloys which are less likely to cause seizing because of large seizing load, and are superior in sliding properties because of drastically small friction coefficient.

However, test pieces of Comparative Examples C1 to C6, which have a composition that is not within the scope of the third aspect, are inferior in at least one of dimensional accuracy, Charpy impact value, tensile strength and wear amount.

### INDUSTRIAL APPLICABILITY

The iron-based sintered alloy, the iron-based sintered alloy member and the oil pump rotor of the present invention are superior in dimensional accuracy, strength and sliding properties and can remarkably contribute to the development of the mechanical industry.

1. A method of manufacturing an iron-based sintered alloy member having a composition consisting of 0.5 to 7% by mass of Cu, 0.1 to 0.98% by mass of C, 0.02 to 0.3% by mass of oxygen, and the balance of Fe and inevitable impurities,
the method comprising:
formulating an Fe powder, a graphite powder and a Cu alloy powder, as raw powders;
mixing the powders to form a powder mixture; and
forming the powder mixture into a green compact and sintering the green compact;
wherein the Cu alloy powder has a composition consisting of 1 to 10% by mass of Fe, 0.2 to 1% by mass of oxygen, and the balance of Cu and inevitable impurities.

2. A method of manufacturing an iron-based sintered alloy member having a composition consisting of 0.5 to 7% by mass of Cu, 0.1 to 0.98% by mass of C, 0.02 to 0.3% by mass of oxygen, 0.0025 to 1.05% by mass of Mn and/or 0.001 to 0.7% by mass of Zn, and the balance of Fe and inevitable impurities,
the method comprising:
formulating an Fe powder, a graphite powder and a Cu alloy powder, as raw powders;
mixing the powders to form a powder mixture;
forming the powder mixture into a green compact and sintering the green compact,
wherein the Cu alloy powder has a composition consisting of 1 to 10% by mass of Fe, 0.2 to 1% by mass of oxygen, 0.5 to 15% mass of Mn and/or 0.2 to 10% by mass of Zn, and the balance of Cu and inevitable impurities.

3. (canceled)

4. (canceled)

5. A method of manufacturing an iron-based sintered alloy member having a composition consisting of 0.5 to 7% by mass of Cu, 0.1 to 0.98% by mass of C, 0.02 to 0.3% by mass of oxygen, 0.001 to 0.14% by mass in total of at least one selected from the group consisting of Al and Si, and the balance of Fe and inevitable impurities,
the method comprising:
formulating an Fe powder, a graphite powder and a Cu alloy powder, as raw powders;
mixing the powders to form a powder mixture; and
forming the powder mixture into a green compact and sintering the green compact,
wherein the Cu alloy powder has a composition consisting of 1 to 10% by mass of Fe, 0.2 to 1% by mass of oxygen, 0.01 to 2% by mass in total of at least one selected from the group consisting of Al and Si, and the balance of Cu and inevitable impurities.

6. A method of manufacturing an iron-based sintered alloy member having a composition consisting of 0.5 to 7% by mass of Cu, 0.1to 0.98% by mass of C, 0.02 to 0.3% by mass of oxygen, 0.0025 to 1.05% by mass of Mn and/or 0.001 to 0.7% bv mass of Zn, 0.001 to 0.14% by mass in total of at least one selected from the group consisting of Al and Si, and the balance of Fe and inevitable impurities,
the method comprising:
formulating an Fe powder, a graphite powder and a Cu alloy powder, as raw powders;
mixing the powders to form a powder mixture; and
forming the powder mixture into a green compact and sintering the green compact,
wherein the Cu alloy powder has a composition consisting of 1 to 10% by mass of Fe, 0.2 to 1% by mass of oxygen, [[and]] 0.5 to 15% by mass of Mn and/or 0.2 to 10% by mass of Zn, 0.01 to 2% by mass in total of at least one selected from the group consisting of Al and Si, and the balance of Cu and inevitable impurities.

7. (canceled)

8. (canceled)

9. The method of manufacturing the iron-based sintered alloy member according to claim 1, wherein the Fe powder, the graphite powder and the Cu alloy powder are formulated so that the content of the graphite powder is from 0.1 to 1.2% by mass, the content of the Cu alloy powder is from 1 to 7% by mass, and the balance is composed of the Fe powder.

10. An oil pump rotor made of an iron-based sintered alloy, comprising an iron-based sintered alloy having a composition consisting of 0.5 to 7% by mass of Cu, 0.1 to 0.98% by mass of C, 0.02 to 0.3% by mass of oxygen, and the balance of Fe and inevitable impurities.

11. An oil pump rotor made of an iron-based sintered alloy, comprising an iron-based sintered alloy having a composition consisting of 0.5 to 7% by mass of Cu, 0.1 to 0.98% by mass of C, 0.02 to 0.3% by mass of oxygen, 0.0025 to 1.05% by mass of Mn and/or 0.001 to 0.7% by mass of Zn, and the balance of Fe and inevitable impurities.

12. (canceled)

13. (canceled)

14. An oil pump rotor made of an iron-based sintered alloy, comprising an iron-based sintered alloy having a composition consisting of 0.5 to 7% by mass of Cu, 0.1 to 0.98% by mass of C, 0.02 to 0.3% by mass of oxygen, 0.001 to 0.14% by mass in total of at least one selected from the group consisting of Al and Si, and the balance of Fe and inevitable impurities.

15. An oil pump rotor made of an iron-based sintered alloy, comprising an iron-based sintered alloy having a composition consisting of 0.5 to 7% by mass of Cu, 0.1 to 0.98% by mass of C, 0.02 to 0.3% by mass of oxygen, 0.0025 to 1.05% by mass of Mn and/or 0.001 to 0.7% by mass of Zn, 0.001 to 0.14% by mass in total of at least one selected from the group consisting of Al and Si, and the balance of Fe and inevitable impurities.

16. (canceled)

17. (canceled)

18. The oil pump rotor according to claim 10, wherein the iron-based sintered alloy has such a texture that base material cells containing Fe, as a main component, Cu and O, which are partitioned with an old Fe powder boundary formed by sintering the Fe powder, as raw powders, are aggregated to form a basis material and the base material cells partitioned with the old Fe powder boundary have such a gradient concentration that the concentration of Cu and O in the vicinity of the old Fe powder boundary is higher than the concentration of Cu and O of the center portion of the base material cell.

19. An iron-based sintered alloy which has a composition consisting of 0.5 to 10% by mass of Cu, 0.1 to 0.98% by mass of C, 0.02 to 0.3% by mass of oxygen, and the balance of Fe and inevitable impurities, and also has a texture composed of an aggregate of base material cells made of an Fe-based alloy containing C, Cu and O, which are partitioned with an old Fe powder boundary formed by sintering an Fe powder, as raw powders,
wherein the base material cells made of the Fe-based alloy containing C, Cu and O, which are partitioned with the old Fe powder boundary, have such a gradient concentration that the concentration of Cu and O in the vicinity of the old Fe powder boundary is higher than the concentration of Cu and O of the center portion of the base material cell.

20. The iron-based sintered alloy according to claim 19, wherein the base material cells made of the Fe-based alloy containing C, Cu and O, which are partitioned with the old Fe powder boundary, have such a gradient concentration that the concentration of Cu and O is maximum in the vicinity of the old Fe powder boundary, while the concentration of Cu and O decreases toward the center portion of the base material cell and reached a minimum value at the center of the base material cell.

21. A method of manufacturing the iron-based sintered alloy member of claim 19, which comprises formulating an Fe powder, a graphite powder and a Cu alloy powder having a composition consisting of 1 to 10% by mass of Fe, 0.2 to 1% by mass of oxygen, and the balance of Cu and inevitable impurities, mixing the powders to form a powder mixture, press-forming the powder mixture into a green compact and sintering the green compact in a hydrogen atmosphere containing nitrogen at a temperature of 1090 to 1300° C.

22. The method of manufacturing the iron-based sintered alloy member according to claim 2, wherein the Fe powder, the graphite powder and the Cu alloy powder are formulated so that the content of the graphite powder is from 0.1 to 1.2% by mass, the content of the Cu alloy powder is from 1 to 7% by mass, and the balance is composed of the Fe powder.

23. The method of manufacturing the iron-based sintered alloy member according to claim 5, wherein the Fe powder, the graphite powder and the Cu alloy powder are formulated so that the content of the graphite powder is from 0.1 to 1.2% by mass, the content of the Cu alloy powder is from 1 to 7% by mass, and the balance is composed of the Fe powder.

24. The method of manufacturing the iron-based sintered alloy member according to claim 6, wherein the Fe powder, the graphite powder and the Cu alloy powder are formulated so that the content of the graphite powder is from 0.1 to 1.2% by mass, the content of the Cu alloy powder is from 1 to 7% by mass, and the balance is composed of the Fe powder.

25. The oil pump rotor according to claim 11, wherein the iron-based sintered alloy has such a texture that base material cells containing Fe, as a main component, Cu and O, which are partitioned with an old Fe powder boundary formed by sintering the Fe powder, as raw powders, are aggregated to form a basis material and the base material cells partitioned with the old Fe powder boundary have such a gradient concentration that the concentration of Cu and O in the vicinity of the old Fe powder boundary is higher than the concentration of Cu and O of the center portion of the base material cell.

26. The oil pump rotor according to claim 14, wherein the iron-based sintered alloy has such a texture that base material cells containing Fe, as a main component, Cu and O, which are partitioned with an old Fe powder boundary formed by sintering the Fe powder, as raw powders, are aggregated to form a basis material and the base material cells partitioned with the old Fe powder boundary have such a gradient concentration that the concentration of Cu and O in the vicinity of the old Fe powder boundary is higher than the concentration of Cu and O of the center portion of the base material cell.

27. The oil pump rotor according to claim 15, wherein the iron-based sintered alloy has such a texture that base material cells containing Fe, as a main component, Cu and O, which are partitioned with an old Fe powder boundary formed by sintering the Fe powder, as raw powders, are aggregated to form a basis material and the base material cells partitioned with the old Fe powder boundary have such a gradient concentration that the concentration of Cu and O in the vicinity of the old Fe powder boundary is higher than the concentration of Cu and O of the center portion of the base material cell.
